(19) United States
(12) Patent Application Publication
(10) Pub. No.: US 2021/0051294 A1
(43) Pub. Date: Feb. 18, 2021

(54) CONTENT AWARE AUTOMATIC BACKGROUND BLURRING

(71) Applicant: Microsoft Technology Licensing, LLC, Redmond, WA (US)

(72) Inventors: Dominic Roedel, Prague (CZ); Philipp Steinacher, Berlin (DE); Mario Novoselec, Prague (CZ)

(21) Appl. No.: 16/538,559

(22) Filed: Aug. 12, 2019

(51) Int. Cl. H04N 7/14; H04N 7/15; H04L 12/18; G06T 5/00

(52) U.S. Cl. CPC H04N 7/147; G06T 5/002; H04L 12/1827; H04N 7/152

(57) ABSTRACT

A system determines whether to obscure a portion of an image frame of a video. The system receives a video stream comprising a plurality of video frames and determines whether a portion of a video frame of the plurality of video frames includes a feature. The feature may be a detected marker in the video frame or video data that matches contents of a file marked in a database for obfuscation. The system further obfuscates the portion of the video frame based on the determination that the portion of the video frame includes the feature and replaces the portion of the video frame with the obfuscated portion of the video frame. The system may then communicate the video stream to a remote device, wherein the video stream comprises the video with the obfuscated portion.

### TECHNICAL FIELD

The subject matter disclosed herein generally relates to obfuscating objects that appear in a video communicated during a communication session and, in particular, to applying an obfuscation technique to an object that appears in a video communicated during a communication session without requiring a user to identify the object to be obfuscated.

### BACKGROUND

People have a variety of means of communicating with each other. One way of communicating is to use video conferencing, where users conduct a meeting using various computing devices to provide and/or view video streams of each other. Through video conferencing, users can see each other's facial expressions and interact with each other as if the meeting was occurring in real life. In addition, a host or other designated user may provide a video stream of a program or electronic file being displayed on his or her computing device. Sometimes referred to as “screen sharing,” the displayed program or displayed electronic file allows the viewing users to see the same program or electronic file as the host, and further allows the viewing users to see changes to the shared program or electronic file in real-time (or near real-time). Screen sharing is often used in group collaboration meetings, where members of the group may elect to change one file or program, and the one file or program resides on the computing device of a particular user.

One of the challenges with video conferencing and screen sharing is that the host may inadvertently display an object that is not meant for viewing by one or more users of the video conference. For example, an object (e.g., a file) may be considered confidential and the host may inadvertently display it, such as through video captured by a camera or by inadvertently sharing it through screen sharing. Once the object is viewed, the host cannot then force the other viewing users to forget what they saw. Although the host may manually obfuscate the confidential object, the host may forget or the video conference may occur on short notice and not provide the host the opportunity to obfuscate the confidential object. Thus, there are shortcomings in trying to manually obfuscate an object prior to, or during, the video conference.

### SUMMARY

To address these and other problems that arise within the field of obfuscating confidential information, this disclosure provides a mechanism for automatically obfuscating content that appears in a video, for example based on whether a particular marker, logical or physical, has been attached to the content or whether the content includes words and/or pictures that are meant to stay confidential.

In one embodiment, a communication session server maintains an electronic file repository, such as a document management server (DMS) database, of electronic files for an organization, such as a private company, an educational institution, a government agency, or the like. Users that are members of the organization, such as employees of the organization, may upload electronic files to the DMS database via a client device in communication with the communication session server. Examples of electronic files include, but are not limited to, word processing files, spreadsheet files, financial files, audio files, image files, audiovisual files, or any other type of electronic file or combinations thereof.

As the electronic files are uploaded to the DMS database, the communication session server may train an obfuscation model using a machine-learning algorithm, where a predetermined number of the uploaded electronic files (e.g., 1000 electronic files) form an initial training set of data for the obfuscation model. Training the obfuscation model may include training the obfuscation model to recognize the words and/or images that appear in the uploaded electronic files. In this embodiment, the uploaded electronic files are considered confidential to the organization such that the communication session server re-trains and/or updates the obfuscation model as electronic files are added to the DMS database.

In another embodiment, the electronic files are uploaded to the DMS database with one or more metadata attribute values. The metadata attributes may include, but are not limited to, author name, authorship date, last modified date, location date, and a confidentiality attribute. In one embodiment, the confidentiality attribute may be assigned a “Yes” or “No” value, where the confidentiality attribute indicates whether the electronic file is considered confidential. Where the attribute value for the confidentiality attribute includes a “Yes” or “No” value, the communication session server may train the obfuscation model using those electronic files that have a “Yes” value for the confidentiality attribute. In one embodiment, the confidentiality attribute is automatically assigned a default value, such as “Yes,” at the time the electronic file is created. In another embodiment, a user or other member of the organization may modify the confidentiality attribute to a particular value.

In yet another embodiment, the confidentiality attribute may be selected from a gradient of confidentiality values, where the confidentiality value indicates a degree of confidentiality. For example, the values for the confidentiality attribute may be selected from a group comprising “No,” “Confidential,” “Secret,” and “Top Secret,” where “No” indicates that the electronic file is not confidential and “Top Secret” indicates that the electronic file has the highest degree of confidentiality. The communication session server may then train an obfuscation model using those electronic files having a predetermined value selected from the confidentiality values (e.g., having a “Confidential,” “Secret,” or “Top Secret” value), and correlate the confidentiality values with the trained obfuscation model. Although four confidentiality values are provided as an example, one of ordinary skill in the art will appreciate that the confidentiality values may include more, or less, than four confidentiality values.

The obfuscation model may then be used to detect whether an object appearing in an image or video frame is likely to be a confidential object and, further still, which level of confidentiality likely applies to the detected object. In one embodiment, the obfuscation model returns a set of probability values indicating the likelihood that the detected object is a confidential object and the likelihood that a particular level of confidentiality applies to the detected object. A first probability threshold (e.g., 60%) may be established that, when met or exceeded, means that the detected object is be identified as being confidential. A second probability threshold (or group of probability thresholds) may also be established for each of the confidentiality attribute values and, when a particular probability threshold is met or exceeded, the detected object is assigned the corresponding confidentiality level. In the event that two or more of the probability thresholds are exceeded for the confidentiality levels, the detected object may be assigned the highest level of confidentiality.

In yet a further embodiment, the communication session server may train the obfuscation model using a machine-learning technique to recognize a physical object as being a confidentiality marker, where the confidentiality marker indicates that content to which the confidentiality marker is attached is to be identified as confidential. In one embodiment, the obfuscation model is trained with a plurality of images (e.g., 500 images) identified with a confidentiality marker. Examples of machine-learning techniques include Linear Regression, Logistic Regression, Classification and Regression Trees (CART), Naïve Bayes, k-Nearest Neighbor (KNN), Apriori, k-means, Principal Component Analysis (PCA), Bagging with Random Forests, Region-Based Convolutional Neural Network (R-CNN), You-Only-Look-Once (YOLO) and other such machine-learning techniques.

In an alternative embodiment, template matching may be employed to determine whether displayed content is confidential or whether the displayed content is likely to include a confidentiality marker. Where template matching is used, the template matching techniques that may be used include, but are not limited to, sum of squared difference, normalized sum of square differences, cross-correlation, normalized cross-correlation, correlation-coefficient, and other such template matching techniques or combinations thereof.

Additionally, and/or alternatively, to being a physical object, the confidentiality marker may be a logical marker, such as metadata, that indicates that particular content is confidential or should be obfuscated. For example, there may be instances where content being transmitted from an originating device, such as a video being transmitted by a client device or a video being distributed by the communication session server, includes non-confidential and confidential content. In this example, the communication session server may not have yet trained the obfuscation model to recognize the confidential content of the content being transmitted. Accordingly, the transmitted content may include metadata, such as the confidentiality attribute, that indicates which portions of the transmitted content are the confidential portions. In this embodiment, this disclosure contemplates that the metadata associated, or embedded, with the transmitted content is a logical marker indicating that particular content is to be obfuscated.

The communication session server may be in communication with one or more computing devices. The computing devices may communicate documents and/or files that have been marked (or will be marked) as confidential to the communication session server (e.g., via a DMS access client). In turn, the communication session server may communicate the obfuscation model and/or the image templates to the computing devices. Using a computing device, a user may initiate a communication session, such as a live video stream, with another computing device in communication with the communication session server. As the computing device is processing the live video stream, the computing device may employ an image recognition algorithm on the video frames of the live video stream to determine whether the video frames of the live video stream contain an object to be obfuscated. In applying the image recognition algorithm, the computing device may leverage the obfuscation model and/or the image templates previously communicated by the communication session server.

When an object, or a confidentiality marker associated with content marked for obfuscation, is detected according to the obfuscation model and/or the template matching, the computing device may then obfuscate the object. In one embodiment, the computing device uses an edge detection technique to identify the edges of the detected object, and then applies an obfuscation technique (e.g., blurring) to obfuscate the object. The video frames with the obfuscated object are then communicated to other computing devices that are attendees (e.g., active or passive attendees) of the communication session. Additionally, and/or alternatively, the computing device may transmit the video frame with the obfuscated object to those computing devices that are associated with a user account that does not have a security clearance to view the obfuscated object. User accounts that have the requisite clearance are sent a video frame that does not have the detected object being obfuscated. In this way, user accounts that are authorized to view the object are able to do so, while user accounts that are not authorized to view the object receive a live video stream with the object being obfuscated.

In one embodiment, the computing device that is transmitting the content is performing the obfuscation of one or portions of the content. In another embodiment, the computing device transmits content to the communication session server, where the communication session server performs the obfuscation on one or more portions of the transmitted content, and then communicates the content transmitted by the computing device (with or without the obfuscated objects) to other remote devices that are consumers of the transmitted content, with or without the one or more portions of the transmitted content having been obfuscated.

In this way, the disclosed subject matter provides for transmitting a live video stream, where obfuscation is automatically performed on a detected object without a user having to identify the object to be obfuscated. This allows the attendees of the live video stream to consume and/or partake in the live video stream without having to focus on whether an object shown in the live video stream should be obfuscated. Further still, the object may appear obfuscated based on a security clearance associated with a user account; thus, a user account that does not have the requisite security clearance is able to partake in and/or consume a live video stream that the user account would otherwise be prohibited from viewing.

To implement the foregoing solutions, this disclosures provides for a method comprising receiving first content data for video streaming to a remote device and determining that a portion of the first content data includes a feature by parsing the first content data, wherein the feature comprises a detected marker in the first content data or second content data in a database, wherein the second content data is marked for obfuscation. The method also includes obfuscating the portion of the first content data in an output video stream based on the determination that the portion of the first content data includes the feature, and communicating the output video stream to the remote device, wherein the output video stream comprises the obfuscated portion of the first content data.

In another embodiment of the method, the detected marker in the first content data comprises a predetermined metadata attribute value, and determining that the portion of the first content data includes the feature comprises determining that a metadata attribute of the first content data corresponds to the predetermined metadata attribute value.

In a further embodiment of the method, the first content data comprises a plurality of image frames, and the detected marker in the first content data comprises a specified physical object having been identified in an image frame of the plurality of image frames.

In yet another embodiment of the method, the first content data comprises a plurality of image frames, and determining that the portion of the first content data includes the feature comprises comparing an image frame selected from the plurality of image frames with the second content data.

In yet a further embodiment of the method, receiving the first content data comprises receiving a live video stream from an image sensor in communication with a client device, and communicating the output video stream comprises transmitting the live video stream after obfuscating the portion of the first content data.

In another embodiment of the method, determining that the portion of the first content data includes the feature comprises storing the first content data in a data buffer, and performing the determination on the first content data stored in the data buffer.

In a further embodiment of the method, obfuscating the portion of the first content data comprises blurring the portion of the first content data.

In yet another embodiment of the method, determining whether a user account having access to the output video stream is authorized to view the portion of the first content data determined as including the feature, and obfuscating the portion of the first content data is further based on a determination that the user account is not authorized to view the portion of the first content data.

In yet a further embodiment of the method, the method includes receiving a request from a client device, invoking a stream function, to stream the first content data to a plurality of remote devices logged into a communication session and, in response to the received request, negotiating with the client device to receive the first content data. The method further includes streaming the output video stream to at least one of the plurality of remote devices.

This disclosure also describes a system for determining whether to obscure a portion of an image, where the system comprises a computer storage device having computer-executable instructions stored thereon, and a processor that, having executed the computer-executable instructions, configures a system to perform a plurality of operations comprising receiving first content data for video streaming to a remote device and determining that a portion of the first content data includes a feature by parsing the first content data, wherein the feature comprises a detected marker in the first content data, or second content data in a database, wherein the second content data is marked for obfuscation. The plurality of operations further comprises obfuscating the portion of the first content data in an output video stream based on the determination that the portion of the first content data includes the feature, and communicating the output video stream to the remote device, wherein the output video stream comprises the obfuscated portion of the first content data.

In another embodiment of the system, the detected marker in the first content data comprises a predetermined metadata attribute value, and determining that the portion of the first content data includes the feature comprises determining that a metadata attribute of the first content data corresponds to the predetermined metadata attribute value.

In a further embodiment of the system, the first content data comprises a plurality of image frames, and the detected marker in the first content data comprises a specified physical object having been identified in an image frame of the plurality of image frames.

In yet another embodiment of the system, the first content data comprises a plurality of image frames, and determining that the portion of the first content data includes the feature comprises comparing an image frame selected from the plurality of image frames with the second content data.

In yet a further embodiment of the system, receiving the first content data comprises receiving a live video stream from an image sensor in communication with a client device, and communicating the output video stream comprises transmitting the live video stream after obfuscating the portion of the first content data.

In another embodiment of the system, determining that the portion of the first content data includes the feature comprises storing the first content data in a data buffer, and performing the determination on the first content data stored in the data buffer.

In a further embodiment of the system, obfuscating the portion of the first content data comprises blurring the portion of the first content data.

In yet another embodiment of the system, the plurality of operations further comprises determining whether a user account having access to the output video stream is authorized to view the portion of the first content data determined as including the feature, and obfuscating the portion of the first content data is further based on a determination that the user account is not authorized to view the portion of the first content data.

In yet a further embodiment of the system, the plurality of operations further comprises receiving a request from a client device, invoking a stream function, to stream the first content data to a plurality of remote devices logged into a communication session and, in response to the received request, negotiating with the client device to receive the first content data. The plurality of operations also comprises streaming the output video stream to at least one of the plurality of remote devices.

This disclosure also describes yet another embodiment of a system for determining whether to obscure a portion of an image, where the system comprises means for receiving first content data for video streaming to a remote device, and means for determining that a portion of the first content data includes a feature by parsing the first content data, wherein the feature comprises a detected marker in the first content data, or second content data in a database, wherein the second content data is marked for obfuscation. The system also includes means for obfuscating the portion of the first content data in an output video stream based on the determination that the portion of the first content data includes the feature, and means for communicating the output video stream to the remote device, wherein the output video stream comprises the obfuscated portion of the first content data.

In another embodiment of the system, the detected marker in the first content data comprises a predetermined metadata attribute value, and the means for determining that the portion of the first content data includes the feature further determines that a metadata attribute of the first content data corresponds to the predetermined metadata attribute value.

In a further embodiment of the system, the first content data comprises a plurality of image frames, and the detected marker in the first content data comprises a specified physical object having been identified in an image frame of the plurality of image frames.

In yet another embodiment of the system, the first content data comprises a plurality of image frames, and the means for determining that the portion of the first content data includes the feature further compares an image frame selected from the plurality of image frames with the second content data.

In yet a further embodiment of the system, the means for receiving the first content data further receives a live video stream from an image sensor in communication with a client device, and the means for communicating the output video stream further transmits the live video stream after obfuscating the portion of the first content data.

In another embodiment of the system, the means for determining that the portion of the first content data includes the feature further stores the first content data in a data buffer, and performs the determination on the first content data stored in the data buffer.

In a further embodiment of the system, obfuscating the portion of the first content data further blurs the portion of the first content data.

In yet another embodiment of the system, the system includes means for determining whether a user account having access to the output video stream is authorized to view the portion of the first content data determined as including the feature, and the means for obfuscating the portion of the first content data further obfuscates the portion of the first content data based on a determination that the user account is not authorized to view the portion of the first content data.

In yet a further embodiment of the system, the system includes means for receiving a request from a client device, invoking a stream function, to stream the first content data to a plurality of remote devices logged into a communication session, means for negotiating with the client device to receive the first content data in response to the received request, and means for streaming the output video stream to at least one of the plurality of remote devices.

### BRIEF DESCRIPTION OF THE DRAWINGS

Some embodiments are illustrated by way of example and not limitation in the figures of the accompanying drawings.

FIG. 1 is a block diagram illustrating a networked system that includes various types of computing devices in communication with a communication server, according to an example embodiment.

FIG. 2 illustrates the components of a client device illustrated in FIG. 1, according to an example embodiment.

FIG. 3 illustrates the components of the communication session server illustrated in FIG. 1, according to an example embodiment.

FIG. 4 illustrates a graphical user interface where client devices are communicating via a video conference, according to an example embodiment.

FIG. 5 illustrates a graphical user interface where an object has been obfuscated in one of the video streams of the client devices illustrated in FIG. 4, according to an example embodiment.

FIG. 6 illustrates a method, in accordance with an example embodiment, for training and updating an obfuscation model for the client devices of FIG. 1.

FIGS. 7A-7B illustrate a method, in accordance with an example embodiment, for obfuscating an object appearing in a video stream communicated by one of the client devices illustrated in FIG. 1.

FIG. 8 is a block diagram illustrating components of a machine, according to some example embodiments, able to read instructions from a machine-readable medium (e.g., a machine-readable storage medium or machine-readable storage device) and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

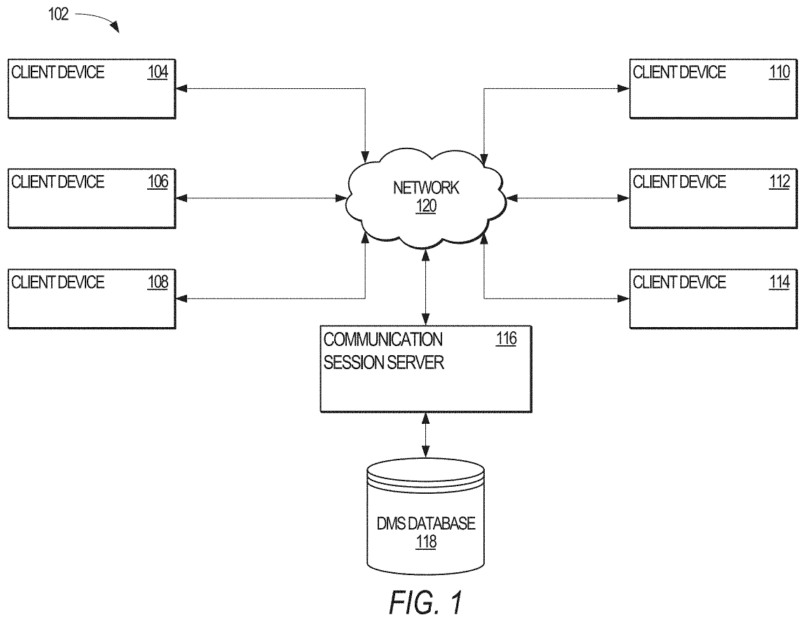

FIG. 1 is a block diagram illustrating a networked system 102 where client devices 104-114 are in communication with a communication session server 116 via a network 120. The communication session server 116 is communicatively coupled with a DMS database 118. The client devices 104-114 may retrieve and/or send data to and from the communication session server 116 via the network 120. In turn, the communication session server 116 may store and/or retrieve data from the DMS database 118. The communication session server 116 may also relay live video streams from the client devices 104-114 via the network 120, and provide the client devices 104-114 with one or more obfuscation model(s) and/or image template(s) via the network 120.

The client devices 104-114 may comprise different types of computing devices. The computing devices include, but are not limited to, a mobile phone, desktop computer, laptop, portable digital assistant (PDA), smart phone, tablet, ultra book, netbook, laptop, multi-processor system, microprocessor-based or programmable consumer electronic, or any other communication device that a user may utilize to perform various computing tasks (e.g., accessing the Internet, making a phone call, conducting a video conference, etc.). In some embodiments, the client devices 104-114 may comprise a display or display module (not shown) to display information (e.g., in the form of user interfaces). In further embodiments, the client devices 104-114 may comprise one or more of touch screens, accelerometers, gyroscopes, cameras, microphones, global positioning system (GPS) devices, and so forth.

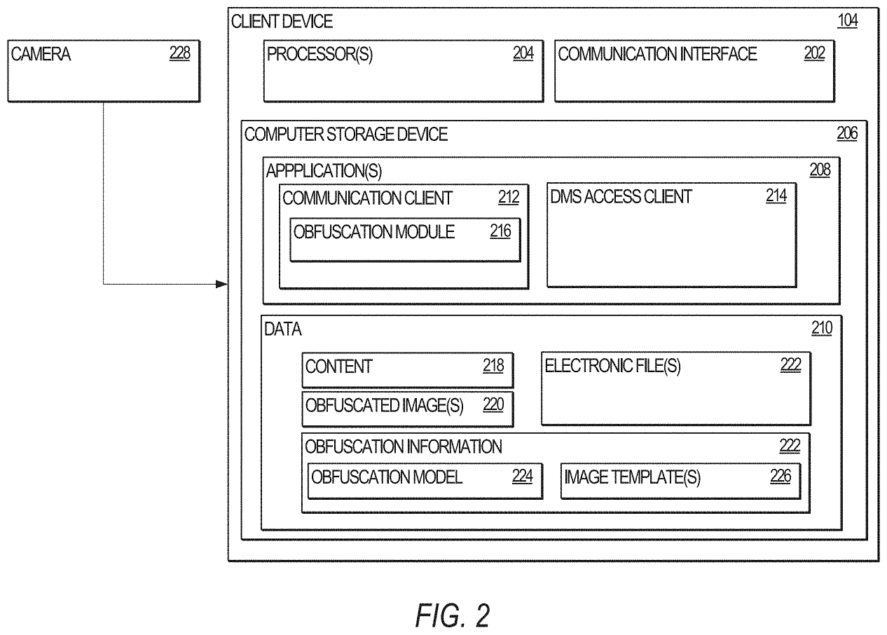

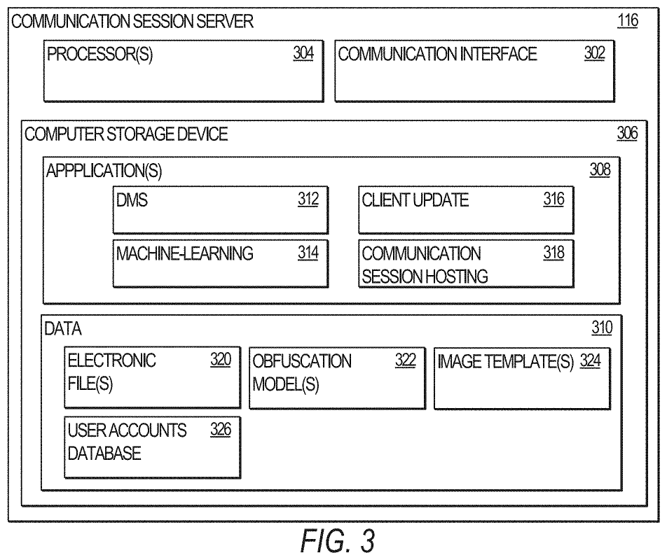

The communication session server 116 may be instantiated as a server that provides multiple services to the client devices 104-114. For example, the communication session server 116 may provide document management services and/or communication session services to the client devices 104-114. In general, a DMS stores, manages, tracks, and provides access to, electronic files. However, a DMS may also manage other types of electronic files, such as audio files, video files, presentation files, and other types of electronic files. One example of a DMS that may be instantiated by the communication session server 116 is Microsoft® Sharepoint. As discussed below with reference to FIGS. 2-3, the client devices 104-114 may use an DMS access client to upload electronic files to the communication session server 116 for storing in the DMS database 118.

The communication session server 116 may also provide communication services, including live video streaming services, to the client devices 104-114. In one embodiment, the communication session server 116 facilitates the establishment of a communication session between two or more of the client devices 104-114. The communication session may be an audio-only communication session, such as a Voice Over IP (VoIP) phone call, and use various signaling and/or audio protocols for establishing the communication session including, but not limited to, User Datagram Protocol (UDP), Transmission Control Protocol (TCP), Real-Time Transport Protocol (RTP), Real-Time Transport with Control Protocol (RTCP), H.323, Real-Time Streaming Protocol (RTSP), Session Initiation Protocol (SIP), and other such protocols, or combinations thereof. The communication session may also be a video stream (with or without audio) and use similar protocols for establishing the video stream including, but not limited, RTP, RTCP, RTSP, UDP, TCP, and any other protocols or combinations thereof. One of ordinary skill in the art will appreciate that the video stream may be a pre-recorded video stream (e.g., an audiovisual file stored in repository) or may be a live video stream (e.g., a video captured with a camera and communicated in approximately real-time as the video is being captured). Where a live video stream is communicated by the communication session server 116, there may be a delay in the transmission of the live video stream, such as 2-3 seconds, from the time that the video was captured by a camera. Thus, the transmission of a live video stream may be in substantially real-time as the video was recorded. Similarly, each of the client devices 104-114 may instantiate a client application for communicating with the communication session server 116, such as Microsoft® Skype for Business or Microsoft® Teams.

As evident from the foregoing description, the communication session server 116 may implement various server applications to provide the services to the client devices 104-114; thus, the communication session server 116 may instantiate both a DMS and a communication session server. Furthermore, while FIG. 1 illustrates the communication session server 116 as a single box, one of ordinary skill in the art will appreciate that the communication session server 116 may be distributed across multiple computing devices and/or servers, including different processors, memories, and so forth.

Although the foregoing paragraph describes an implementation of the communication session server 116 acting as an intermediary between the client devices 104-114, the communication session may be established between the client devices 104-114 without the communication session server 116 acting as an intermediary. In one embodiment, the communication session server 116 provides awareness and endpoint information for the communication session and initially establishes the communication session between the client devices 104-114. After establishing the communication session between the client devices 104-114, network traffic (e.g., audio, video, images, files, etc.) communicated during the communication session may pass through network 120 but may not pass through the communication session server 116. In this implementation, one of the client devices 104-114 may serve as a hosting device to provide the functionalities that would be provided by the communication session server 116, such as the routing of the network traffic and/or any processing of the video and/or audio streams. In establishing the communication session, the communication session server 116 may select a client device as the hosting device, and then transfer processing of the communication session to the selected hosting device. In one embodiment, the hosting device is selected based on its available computing resources including, but not limited to, CPU speed, available non-volatile memory, available volatile memory, network bandwidth availability, and other such computing resources or combinations thereof.

The client devices 104-114 and the communication session server 116 may be implemented as a client/server relationship, as a peer-to-peer relationship (e.g., client devices 104-114 are communicatively connected as peer devices), or a server-to-server relationship (e.g., the client devices 104-114 are implemented as servers and communicate with each other and/or the communication session server 116 to provide various services to one another).

The network 120 disposed between the client devices 104-114 and the communication session server 116 may include one or more types of networks. For example, the network 120 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a Wi-Fi network, a WiMAX network, another type of network, or a combination of two or more such networks.

FIG. 2 illustrates the components of the client device 104 illustrated in FIG. 1, according to an example embodiment. As shown in FIG. 2, and in one embodiment, the client device 104 includes various components 202-210. These components 202-210 include, but are not limited to, a communication interface 202, one or more processor(s) 204, a computer storage device 206, various application(s) 208 and data 210 that may be used by, and/or supports, the application(s) 208. The client device 104 may also be in communication with a camera 228, via the communication interface 202, where the camera 228 captures video and communicates the captured video to the client device 104. The captured video may be stored as content 218 (discussed below). The camera 228 may include one or more different types of image sensors for capturing the video including, but not limited to, a semiconductor charge-coupled devices (CCD) type, a complementary metal-oxide-semiconductor (CMOS) type, an N-type metal-oxide-semiconductor (NMOS) type, or other any type of image sensor or combinations thereof.

The various component 202-210 of the client device 104 may reside on a single device or may be distributed across several devices in various arrangements. The various components 202-210 of the client device 104 may access one or more computer storage devices for configuration information and/or implementation algorithms, and each of the various components 202-210 may be in communication with one another (e.g., via one or more communication buses or the like). Further, while the components 202-210 of FIG. 2 are discussed in the singular sense, it will be appreciated that in other embodiments multiple instances of the components 202-210 may be employed.

One or more of the components 208-210 may be implemented in hardware and/or software. In one embodiment, the components 208-210 are implemented as dedicated circuits, such as Application Specific Integrated Circuits (ASICs) where the dedicated circuits are configured to perform predetermined functions. Additionally, and/or alternatively, the components 208-210 may be implemented as software, where the processor(s) 204 are configured to execute computer-readable instructions that implement the components 208-210. Furthermore, combinations of the foregoing are possible, where some components are implemented as dedicated circuits and other modules are implemented in software. In this manner, the client device 104 may include components 208-210 that are implemented in hardware and/or software.

The communication interface 202 is configured to communicate with the other client devices 106-114 and/or the communication session server 116. In this regard, communication with the client devices 106-114 and/or the communication session server 116 includes receiving data from, and sending data to, the communication session server 116 and/or the other client devices 106-114. Examples of data communicated between the client device 104 and the communication session server 116 includes video data 218, such as a live video stream captured by a camera 228 in communication with the client device 104 or a prerecorded video stored at the client device 104, various electronic files 222, one or more image(s) 220 obtained from the video data 218, and obfuscation information 222. Examples of data communicated between the client device 104 and the other client devices 106-114 include the video data 218 and/or the one or more image(s) 220 obtained from the video data 218. Each of these different data objects are discussed further below.

The communication interface 202 may include one or more wired and/or wireless communication interfaces. For example, the communication interface 202 may include a wireless transceiver, a Bluetooth® radio, and/or a wired network interface. In one embodiment, the communication interface 202 is configured to establish a wireless communication channel with the client devices 106-114 and/or the communication session server 116 using one or more wireless communication protocols such as 802.11 b/g/n. Additionally, and/or alternatively, the client device 104 may establish a communication channel with the communication session server 116 and/or the other client devices 106-114 via a wire or other physical medium (e.g., via an Ethernet cable or the like).

The processor(s) 204 are configured to execute computer-readable instructions that implement one or more of the application(s) 208. Additionally, and/or alternatively, the processor(s) 204 may be configured to retrieve computer-readable instructions from the computer storage device 206. The one or more processor(s) 204 may be any type of commercially available processor, such as processors available from the Intel Corporation, Advanced Micro Devices, Texas Instruments, or other such processors. Further still, the one or more processor(s) 204 may include one or more special-purpose processors, such as a Field-Programmable Gate Array (FPGA) or an Application Specific Integrated Circuit (ASIC). The one or more processor(s) 204 may also include programmable logic or circuitry that is temporarily configured by software to perform certain operations. Thus, once configured by such software, the one or more processor(s) 204 become specific machines (or specific components of a machine) uniquely tailored to perform the configured functions and are no longer general-purpose processor(s) 204.

Where the one or more processor(s) 204 implement the applications 208-216 via one or more computer-readable instructions, the computer-readable instructions may be written in one or more computer-programming and/or computer-scripting languages. Examples of such languages include, but are not limited to, C, C++, C#, Java, JavaScript, Perl, Python, or any other computer programming and/or scripting language now known or later developed.

The client device 104 may further include various computer storage device(s) 206 and/or computer-readable medium(s) for storing the application(s) 208 and/or the data 210. The computer storage device 206 includes one or more physical devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “computer storage device” should be taken to include a single device or multiple devices (e.g., a centralized or distributed database, or associated caches and servers) able to store the application(s) 208 and the data 210. Accordingly, the computer storage device 206 may be implemented as a single storage apparatus or device, or, alternatively and/or additionally, as “cloud-based” storage systems or storage networks that include multiple storage apparatus or devices.

The application(s) 208 include an operating system (not shown), a communication client 212 configured to establish a communication session with the other client devices 106-114 and/or the communication session server 116, and a DMS access client 214 used to upload one or more electronic file(s) 222 to the communication session server 116.

In one embodiment, the client device 104 may use the DMS access client 214 to store one or more of the electronic file(s) 222 in the DMS database 118. One example of a DMS access client 214 is Microsoft® OneDrive for Business, which allows a user of the client device 104 to transfer files to and from the DMS database 118 in communication with the communication session server 116.

The electronic file(s) 222 may be stored in a variety of computer-readable formats including, but not limited to text-based formats such as TXT, DOCX, DOC, RTF, ODT, and other such text-based formats; image-based formats such as GIF, JPG, PNG, and other such image-based formats; audio-based formats such as WAV, MP3, M4A, and other such formats; audiovisual-based formats such as AVI, MPG, MKV, and other such formats; or combinations thereof. The foregoing examples of electronic file(s) 222 is not meant to be exhaustive, and one of ordinary skill in the art will appreciate that the client device 104 may upload other types of files to the DMS database 118.

An electronic file may include metadata about the information stored by the electronic file. As described above, examples of metadata attributes include, but are not limited to, an author name of the electronic file, an authorship date of the electronic, a calendar date and/or time when the electronic file was last modified, a geographic location where the electronic file was created, and a confidentiality attribute that indicates whether, and/or the extent to which, the electronic file is confidential. In one embodiment, the confidentiality attribute may be assigned a binary value, (e.g., a “Yes” or “No” value), where the confidentiality attribute indicates whether the electronic file is considered confidential. For example, an author or user with access to the electronic file may modify the value of the confidentiality metadata attribute to the “Yes” or “No” value.

In yet another embodiment, the confidentiality attribute may be selected from a gradient of confidentiality values, where the confidentiality value indicates a degree of confidentiality. For example, the values for the confidentiality attribute may be selected from a group comprising “No,” “Confidential,” “Secret,” and “Top Secret,” where “No” indicates that the electronic file is not confidential and “Top Secret” indicates that the electronic file has the highest degree of confidentiality. One of ordinary skill in the art will appreciate that alternative gradient values may be used, including the names assigned to such gradient values and the number of possible confidentiality values that may be assigned to the confidentiality attribute.

In brief, and discussed further below with reference to FIG. 3, the communication session server 116 may reference the confidentiality attribute to determine whether a machine-learning model should be trained with the corresponding electronic file to recognize the contents of the corresponding electronic file. Where the confidentiality attribute includes a particular value (e.g., “Yes,” “Top Secret,” etc.) that indicates that the electronic file is a confidential or restricted file, the communication sessions server 116 may then add the electronic file to a training dataset on which to train the machine-learning model, and then train the machine-learning model accordingly. The communication session server 116 may then transfer the trained model to the client device 104, which is stored as the obfuscation model 224. The client device 104 may then use the obfuscation model 224 to determine whether an image from a video includes content considered to be confidential or restricted. In another embodiment, the electronic files transferred to the DMS database 118 by the client device 104 are each considered confidential or restricted, and the communication session server 116 trains the machine-learning model on each of the electronic files stored in the DMS database 118.

The application(s) 208 also include a communication client 212 for establishing a communication session between the client device 104 and the other client devices 106-114 and/or the communication session server 116. As discussed above, communication session may be an audio-only communication session, such as a Voice Over IP (VoIP) phone call or a video stream (with or without audio), where the video stream is a live video stream or a pre-recorded video stream. One example of the communication client 212 is Skype for Business, which is available from the Microsoft Corporation. The communication client 212 may communicate a live video stream that captures video from a camera in communication with the client device 104. Additionally, and/or alternatively, the communication client 212 may communicate a video comprising images captured from a screen sharing session of the client device 104.

The communication client 212 may be extensible via various plug-ins, modules, and libraries that extend the functionalities of the communication client 212. For example, the communication client 212 may be extended using one or more development platforms, such as the Component Object Model (COM), Visual Basic, Microsoft Office Developer, the Visual Studio Tools for Office (VSTO), the Office Add-ins Platform, or combinations thereof. As known to one of ordinary skill in the art, the foregoing platforms allow a programmer or developer to develop a small application (e.g., an “add-in”) that extends the functionalities of the communication client 212, and allow the communication 212 to perform different and/or additional functions from the communication client's 212 initial state.

Where the communication session involves video (with or without audio), the video may be stored as content 218. The content 218 may include a pre-recorded video that the communication client 212 communicates during the communication session. The content 218 may also include a segment or portion of a live video stream being communicated by the communication client 212. For example, the client device 104 may be configured to buffer a predetermined amount of the content 218 in the data 210, where the data 210 is used as a data buffer to buffer the predetermined amount of content 218. The predetermined amount of content 218 may be any size of the video stream being communicated by the communication client 212, including the entirety of the video stream or portions thereof. The amount of the content 218 stored in the data 210 may be measured in time (e.g., seconds, minutes, etc.) or data size (e.g., kilobytes, megabytes, gigabytes, etc.).

The content 218 may comprise a plurality of video frame(s) and, the communication client 212 may be extended to include an obfuscation module 216 configured to obfuscate one or more objects that appear in the video frame(s) communicated during a communication session established by the communication client 212. In one embodiment, the obfuscation module 216 determines whether each video frame includes a feature indicating that an object is present in the video frame. The feature may include content that should be obfuscated and/or includes an obfuscation marker that indicates that a particular object or content should be obfuscated. The obfuscation module 216 may determine whether the video frame includes the content to be obfuscated and/or the obfuscation marker by comparing the video frame with the obfuscation model 224 and/or the image template(s) 226. Using the obfuscation model 224, the obfuscation module 216 attempts to match the obfuscation model 224 with the video data represented by the video frame.

In an alternative embodiment, content 218 may include an electronic file that the client device 104 may transmit to the communication session server 116, where the communication session server 116 then facilitates a communication session between the client device 104 and one or more remote devices. The client device 104 and the communication session server 116 may negotiate a communication protocol by which to transfer the content 218, and the communication session server 116 which remote devices are to receive a video, or plurality of images, of the content 218. For example, the user of the client device 104 may designate and/or invite or more user accounts to a communication session, and the communication session server 116 may then send an invitation to the invited user accounts to attend the communication session with the user of the client device 104. Like with the client device 104, the communication session server 116 may also negotiate a communication protocol and/or video quality by which to share the content 218. For example, the communication session server 116 may perform network bandwidth measurements on each of the plurality of remote devices that are to attend the communication session, and then select a video encoding quality based on the network bandwidth measurements. In one embodiment, video encoding quality is correlated to a plurality of ranges of network bandwidth measurements. In this context, video encoding quality may be measured in kilobits per second (kbps) and the network bandwidth measurements may be measured in megabits per second (mbps).

The content 218 may include one or more logical markers indicating which portions of the content 218 are to be obfuscated. Accordingly, when the communication session server 116 transmits a video of the content 218 to the remote devices, the communication session server 116 may obfuscate those portions of the content 218 indicated as being confidential by the logical markers. As discussed, the logical markers may be metadata associated, or embedded with, the content 218. The content 218 may include attributes that label particular portions of the content 218 (e.g., a page number, a paragraph number, an image name, a text field, or other logical labels), and the embedded or associated metadata may reference the logical labels to identify which portions of the content 218 are to be obfuscated. In addition, the metadata attributes may include particular fields used to determine whether a user or user account is authorized to view the obfuscated data, such as a geographic attribute field (e.g., using a two-letter country code to indicate authorized countries), an area code attribute field, a city attribute field, a user role attribute field, and other such metadata attribute fields.

Embedding logical markers within the content 218 may be particularly beneficial where the content 218 should be obfuscated in one geographic location but does not have to be obfuscated in another geographic location. For example, the logical marker may indicate that portions of the content 218 are to obfuscated where the geographic location enforces the European Union's General Data Protection Regulation (GDPR). Accordingly, where a remote device is located in a geographic region that enforces or recognizes the GDPR, and the logical marker indicates that a portion of the content 218 is to be obfuscated in those geographic regions, the remote device receives content 218 where the portions of the content 218 are obfuscated. However, in other geographic regions, such as the United States or Australia, the portions of the content 218 may not be obfuscated as these geographic regions do not recognize or enforce the GDPR. Thus, the content 218 may include logical markers that indicate which portions of the content 218 are to be obfuscated, and these logical markers may further define the context in which the content is to be obfuscated (e.g., based on the geographic location of a remote device, based on a time of day, based on a user account, and so forth).

In one embodiment, the communication session server 116 transfers an obfuscation model 224 to the client device 104, where the communication session server 116 has constructed the obfuscation model 224 using a machine-learning object detection technique and/or image classification technique, such as R-CNN or YOLO. The comparison may be performed at the bit level, such that the obfuscation module 216 parses the video data included in the video frame to identify a pattern of bits corresponding to the obfuscation model 224.

Matching and/or comparing the obfuscation model 224 with the video data represented by the video frame may yield a probability that the video frame includes an object to be obfuscated. In addition, the matching may further yield two-dimensional coordinates (e.g., two or more coordinates) that define a bounding shape of the object to be obfuscated. Where the probability value is greater than or equal to an obfuscation probability threshold (e.g., 70%), the obfuscation module 216 determines that there is an object to obfuscate in the video frame corresponding to the determined two-dimensional coordinates.

In another embodiment, the obfuscation module 216 compares the video frame with one or more image template(s) 226. The image template(s) 226 may correspond to a physical obfuscation marker, where the physical obfuscation marker indicates that the underlying object on which the obfuscation marker was placed should be obfuscated. In one embodiment, the image template(s) 226 correspond to images of a physical marker, where the physical marker has a predetermined shape, colors, and/or patterns. The obfuscation module 216 may determine whether the video frames of the content 218 include the image template(s) 226 by performing an image recognition technique on the video frames using the image template(s) 226 as reference images, such as through template matching. Like with the comparison with the obfuscation model 224, the image recognition approach yields a probability value indicating a likelihood that the video frame includes an object or image that is similar to one or more of the image template(s) 226.

Where the probability value from matching with the image template(s) 226 is greater than or equal to a probability threshold (e.g., 70%), the obfuscation module 216 determines that there is an object to obfuscate in the video frame. The obfuscation module 216 may then perform another image manipulation technique, such as edge detection, to determine the edges of the object to which the detected marker is attached.

As known to one of ordinary skill in the art, edge detection is a process to identify points in a digital image at which the image brightness changes sharply and/or has discontinuities. Although there are many methods for edge detection, they are generally grouped into two categories, search-based and zero-crossing based. Typically, the search-based methods detect edges by first computing a measure of edge strength, usually a first-order derivative expression such as a gradient magnitude, and then searching for local directional maxima of the gradient magnitude using a computed estimate of the local orientation of the edge, usually the gradient direction. In general, zero-crossing based methods search for zero crossings in a second-order derivative expression computed from the digital image in order to find edges, usually the zero-crossings of the Laplacian or the zero-crossings of a non-linear differential expression. In some instances, Gaussian smoothing is applied to the image as a pre-processing step to edge detection. In one embodiment, the edge detection on the video frame may be performed after the obfuscation module 216 has determined that the video frame includes an object that is likely to match (e.g., returns a probability value greater than or equal to a probability value threshold) with one or more of the image template(s) 226. Although the foregoing edge detection technique is discussed with reference to the use of an obfuscation marker and the image template(s) 226, edge detection may also be applied where the obfuscation module 216 uses the obfuscation model 224 to determine whether the video frame includes an object to be obfuscated.

The obfuscation module 216 is further configured to obfuscate an object detected in the video frame using different methodologies. In this regard, the methodologies may include applying an image manipulation or image modification technique to a portion of the video frame, such as a Gaussian blur, blocking, pixelating, or any other image manipulation or image modification technique that results in the obfuscation of the video frame or portion of the video frame. In another embodiment, the obfuscation module 216 replaces the colors of particular pixels (e.g., those pixels corresponding to the object to be obfuscated) with a predetermined color (e.g., white, black, red, etc.). The pixel color replacement may be performed at the bit level to ensure that the information conveyed by the object and shown in the video frame is obfuscated. The obfuscation module 216 may be configured to automatically apply a particular image manipulation or image modification technique to the video frame or a user of the client device 104 may select which image manipulation or image modification to apply to the video frame.

In one embodiment, the obfuscation module 216 applies an obfuscation technique to the video frame in response to a determination that a probability value (e.g., the probability value determined from the obfuscation model 224 and/or the image template(s) 226) meets or exceeds a probability threshold. In one embodiment, the obfuscation module 216 obfuscates the entirety of a detected object. For example, the obfuscation module 216 may obfuscate the object corresponding to the shape defined by the two-dimensional pixels determined via the obfuscation model 224 or the shape determined through edge detection where template matching was used. In another embodiment, the obfuscation model 216 obfuscates a portion of an object to be obfuscated, such as text or content shown by the object in the video frame. In one embodiment, the bounding shapes output by the obfuscation model 216 correspond to content contained within an electronic file (e.g., one or more of the electronic files used to train the obfuscation model 224), and the obfuscation module 216 applies an obfuscation technique to the content shown in the video frame. In this manner, the edges and/or outer periphery of the object may remain intact, while the contents displayed by the object are obfuscated.

The obfuscation module 216 may store the obfuscated video frame(s) as obfuscated image(s) 220. As discussed above a portion of the video frame may appear obfuscated in the obfuscated image(s) 220. The obfuscation module 216 then replaces the video frame within the content 218 with the corresponding obfuscated image selected from the obfuscated image(s) 220. In one embodiment, the obfuscated image(s) 220 are stored in a data buffer, and the obfuscated module 216 selects the replacement obfuscated image from the data buffer. When the content 218 is transmitted to one or more of the other client devices 106-114 in communication with the client device 104, the content 218 includes the obfuscated image(s) 220 such that the detected objects within the content 218 appear obfuscated.

In an alternative embodiment, the obfuscation module 216 may be configured to selectively obfuscate the objects appearing within the content 218 based on one or more user account(s) present in the communication session and in communication with the client device 104. The obfuscation module 216 may be configured to determine a security clearance or authorization clearance required to view the detected object, and then determine which of the user account(s) present in the communication session have the requisite security clearance to view the detected object. The obfuscation module 216 may determine the security clearance required to view the detected object by referencing the obfuscation model 224 and obtaining a likely confidentiality attribute value associated with the detected object. In other words, the communication session server 116 may use the confidentiality attribute value associated with the electronic files used to train the obfuscation model 224 as an input to the obfuscation model 224 itself. Thus, through a machine-learning algorithm, the obfuscation model 224 also outputs a matrix or other data structure that lists the confidentiality attribute values potentially associated with the detected object, and the likelihood that the detected object should be classified with a particular confidentiality attribute value.

As one example, the obfuscation model 224 may output that a detected object has a 90% likelihood of being associated with a “Confidential” confidentiality attribute value, a 70% likelihood of being associated with a “Secret” confidentiality attribute value, a 10% likelihood of being associated with a “Top Secret” confidentiality attribute value, and a 2% likelihood of being associated with a “No” confidentiality attribute value. As the 90% is the greatest probability value from among the probability values and meets or exceeds a probability threshold (e.g., 70%), the obfuscation module 216 may select the “Confidential” confidentiality attribute value as the likely security clearance required to view the object.

To determine the security clearances of the user accounts viewing or participating in the communication session, the obfuscation module 216 may query the communication session server 116 to provide this information. The obfuscation module 216 may query the communication session server 116 at predetermined instances during the communication session, such as when the communication session is initially established, when a user account joins the communication session, when the user account leaves the communication session, and at other such instances.

In response to the query from the obfuscation module 216, the communication session server 116 may reference a user accounts database 326 (illustrated in FIG. 3) to obtain the security clearance value associated with a particular user account (e.g., using a username or other user identifier to query the user accounts database 326). The communication session server 116 then communicates the obtained security clearance values to the obfuscation module 216.

During the transmission of the communication session, the obfuscation module 216 then compares the received security clearance values with the likely security clearance determined via the obfuscation module 216. Where a security clearance value meets or exceeds the likely security clearance, the obfuscation module 216 records that the corresponding user account is authorized to view the object in the content 218. Where user accounts are authorized to view the detected object without obfuscation, the obfuscation module 216 may duplicate (e.g., copy) the video frame (or video frames) where the detected object appears. The obfuscation module 216 may then manipulate or modify the duplicated video frame(s) to create the obfuscated image(s) 220. When the content 218 (or the portion of the content 218 that is buffered in the memory) is transmitted to one or more of the client devices 106-114, the client device 104 may transmit a video where the object appears obfuscated in one or more of the video frame(s) and a video where the object does not appear obfuscated in one or more of the video frame(s). In one embodiment, the client device 104 transmits a content 218 for each user account attending, or participating in, the communication session. In another embodiment, the client device 104 transmits a content 218 for each client device in communication with the client device 104 and party to the communication session. In this manner, those user account(s) that are authorized to view the detected object without obfuscation can do so, and those user account(s) that are not authorized to view the detected object without obfuscation can view the content 218 with the detected object being obfuscated.

FIG. 3 illustrates the components of the communication session server 116 illustrated in FIG. 1, according to an example embodiment. As shown in FIG. 2, and in one embodiment, the communication session server 116 includes various components 302-310. These components 302-310 include, but are not limited to, a communication interface 302, one or more processor(s) 304, a computer storage device 306, various application(s) 308 and data 310 that may be used by, and/or supports, the application(s) 308.

The various component 302-310 of the communication session server 116 may reside on a single device or may be distributed across several devices in various arrangements. The various components 302-310 of the communication session server 116 may access one or more computer storage devices for configuration information and/or implementation algorithms, and each of the various components 302-310 may be in communication with one another (e.g., via one or more communication buses or the like). Further, while the components 302-310 of FIG. 3 are discussed in the singular sense, it will be appreciated that, in other embodiments, multiple instances of the components 302-310 may be employed.

One or more of the components 308-310 may be implemented in hardware and/or software. In one embodiment, the components 308-310 are implemented as dedicated circuits, such as Application Specific Integrated Circuits (ASICs) where the dedicated circuits are configured to perform predetermined functions. Additionally, and/or alternatively, the components 308-310 may be implemented as software, where the processor(s) 304 are configured to execute computer-readable instructions that implement the components 308-310. Furthermore, combinations of the foregoing are possible, where some components are implemented as dedicated circuits and other modules are implemented in software. In this manner, the communication session server 116 may include components 308-310 that are implemented in hardware and/or software.

The communication interface 302 is configured to communicate with the other client devices 104-114. In this regard, communication with the client devices 104-114 includes receiving data from, and sending data to, the other client devices 104-114. Examples of data communicated between the client device 104-114 and the communication session server 116 includes video data 218, such as a live video stream or prerecorded video, various electronic file(s) 320, one or more obfuscation model(s) 322 for determining whether a video frame includes an object to be obfuscated, and one or more image template(s) 324 for determining whether a video frame includes an obfuscation marker. As discussed above, the communication session server 116 may also communicate information about one or more user accounts stored in a user accounts database 326.

The communication interface 302 may include one or more wired and/or wireless communication interfaces. For example, the communication interface 302 may include a wireless transceiver, a Bluetooth® radio, and/or a wired network interface. In one embodiment, the communication interface 302 is configured to establish a wireless communication channel with the client devices 104-114 using one or more wireless communication protocols such as 802.11 b/g/n. Additionally, and/or alternatively, the client device 104 may establish a communication channel with the communication session server 116 and/or the other client devices 106-114 via a wire or other physical medium (e.g., via an Ethernet cable or the like).

The processor(s) 302 are configured to execute computer-readable instructions that implement one or more of the application(s) 308. Additionally, and/or alternatively, the processor(s) 304 may be configured to retrieve computer-readable instructions from the computer storage device 306. The one or more processor(s) 304 may be any type of commercially available processor, such as processors available from the Intel Corporation, Advanced Micro Devices, Texas Instruments, or other such processors. Further still, the one or more processor(s) 304 may include one or more special-purpose processors, such as a Field-Programmable Gate Array (FPGA) or an Application Specific Integrated Circuit (ASIC). The one or more processor(s) 304 may also include programmable logic or circuitry that is temporarily configured by software to perform certain operations. Thus, once configured by such software, the one or more processor(s) 304 become specific machines (or specific components of a machine) uniquely tailored to perform the configured functions and are no longer general-purpose processor(s) 304.

Where the one or more processor(s) 304 implement the applications 312-318 via one or more computer-readable instructions, the computer-readable instructions may be written in one or more computer-programming and/or computer-scripting languages. Examples of such languages include, but are not limited to, C, C++, C#, Java, JavaScript, Perl, Python, or any other computer programming and/or scripting language now known or later developed.

The client device 104 may further include various computer storage device(s) 306 and/or computer-readable medium(s) for storing the application(s) 308 and/or the data 310. The computer storage device 306 includes one or more physical devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “computer storage device” should be taken to include a single device or multiple devices (e.g., a centralized or distributed database, or associated caches and servers) able to store the application(s) 308 and the data 310. Accordingly, the computer storage device 306 may be implemented as a single storage apparatus or device, or, alternatively and/or additionally, as “cloud-based” storage systems or storage networks that include multiple storage apparatus or devices.

The application(s) 308 include an operating system (not shown), a DMS 312, a machine-learning application 314, a client update application 316, and a communication session hosting application 318. The DMS 312 is configured to receive and send electronic file(s) 320 to and from the client devices 104-114. The DMS 312 is in communication, via the communication interface 302, with a DMS database 118. Client devices 104-114 may transfer electronic file(s) 320 to and from the communication session server 116 via their own DMS access client, such as the DMS access client 214. As provided above, one example of a DMS 312 is Microsoft® Sharepoint.

The communication session server 116 may store different types of electronic file(s) 320. Similarly to the discussion with reference to FIG. 2, the electronic file(s) 320 may be stored in a variety of computer-readable formats including, but not limited to text-based formats such as TXT, DOCX, DOC, RTF, ODT, and other such text-based formats; image-based formats such as GIF, JPG, PNG, and other such image-based formats; audio-based formats such as WAV, MP3, M4A, and other such formats; audiovisual-based formats such as AVI, MPG, MKV, and other such formats; or combinations thereof. The foregoing examples of electronic file(s) 320 is not meant to be exhaustive, and one of ordinary skill in the art will appreciate that the DMS 312 may store other different types of electronic file(s) 320.

The application(s) 308 also include a machine-learning application 314 that implements one or more of the aforementioned machine-learning algorithms. The communication session server 116 uses the machine-learning application 314 in a variety of ways including training one or more obfuscation model(s) 322 and applying the one or more obfuscation model(s) 322 to a video (e.g., content 218) where the communication session server 116 is designated to act as an intermediary between the client devices 104-114. Examples of machine-learning algorithms that the machine-learning application 314 may implement include Linear Regression, Logistic Regression, Classification and Regression Trees (CART), Naïve Bayes, k-Nearest Neighbor (KNN), Apriori, k-means, Principal Component Analysis (PCA), Bagging with Random Forests, Region-Based Convolutional Neural Network (R-CNN), You-Only-Look-Once (YOLO) and other such machine-learning algorithms.

The machine-learning application 314 may train one or more of the obfuscation model(s) 322 using a training dataset that includes electronic file(s) selected from the electronic file(s) 320. In one embodiment, the machine-learning application 314 constructs the training dataset based on metadata associated with each of the electronic file(s) 320. As described above, the training dataset may be constructed based on metadata indicating that a particular electronic file is confidential or restricted. The machine-learning application 314 may reference a confidentiality attribute of an electronic to determine whether the electronic file should be added to the training dataset.

Where the confidentiality attribute for an electronic file includes a particular value (e.g., “Yes,” “Top Secret,” etc.) that indicates that the electronic file is a confidential or restricted file, the machine-learning application 314 adds the electronic file to the training dataset. In another embodiment, the machine-learning application 314 adds all electronic file(s) 320 from the DMS database 118 to the training dataset. In yet another embodiment, the machine-learning application 314 is configured, by a user or administrator of the communication session server 116, to selectively choose which of the electronic file(s) 320 are added to the training dataset based on their corresponding confidentiality attribute. In this embodiment, electronic file(s) that have a confidentiality attribute value of “Top Secret” or greater may be added to the training dataset, whereas electronic file(s) that have a confidentiality attribute value lower than “Top Secret” may not be added.

The machine-learning application 314 then trains the obfuscation model(s) 322 according to the training dataset. In addition, the machine-learning application 314 may update the obfuscation model(s) 322 using a supplemental training dataset based on modifications to the DMS database 118, such as the addition of electronic file(s), the removal of electronic file(s), or modifications to the electronic file(s). For example, the communication session server 116 may re-train the obfuscation model(s) 322 periodically, such as nightly, hourly, and so forth, to ensure that the obfuscation model(s) 322 include the most current, and confidential, electronic files of the DMS database 118. In another embodiment, the communication session server 116 may re-train the obfuscation model 322 in response to an electronic file be added to, or removed from, the DMS database 118. This approach ensures that the obfuscation model 322 is trained with the most current, and confidential, electronic files of the DMS database 118.

To transfer the obfuscation model(s) 322 to the client devices 104-114, the communication session server 116 includes a client update application 316. Examples of the client update application 316 include the Microsoft® System Configuration Manager, Microsoft® Windows Server Update Services, and other similar client updating applications. The client update application 316 may be configured to transfer the obfuscation model(s) 322 to the client devices 104-114 based on one or more predetermined conditions, such as when the obfuscation model(s) 322 are updated, on one or more predetermined time periods, such as daily or monthly updates, or combinations thereof.

In addition to, or alternatively to, the obfuscation model(s) 322, the client update application 316 may transfer one or more image template(s) 324 to the client devices 104-114. In one embodiment, the image template(s) 324 correspond to images of a physical marker, where the physical marker has a predetermined shape, colors, and/or patterns. The physical marker may be attached (e.g., by a person) to an object that the person believes will appear in a video displayed during a communication session among the client devices 104-114. As discussed above, the physical marker corresponds to an obfuscation marker that indicates that the object to which the physical marker is attached should be obfuscated. Like with the obfuscation model(s) 322, the client update application 316 may transfer the image template(s) 324 to the client devices 104-114 based on a predetermined condition being satisfied (e.g., an update to the image template(s) 324 occurred), on a predetermined time period (e.g., daily, weekly, monthly, etc.), or combinations thereof.

The application(s) 308 also include a communication session hosting application 318 for providing communication session hosting functionalities to the client devices 104-114. One example of a communication session hosting application 318 is Microsoft® Skype for Business Server. In one embodiment, the communication session hosting application 318 initially establishes the communication session among the client devices 104-114, but then one or more of the client devices 104-114 assumes control of the session hosting functions. In another embodiment, the communication session hosting application 318 acts as an intermediary among the client devices 104-114 such that information transmitted by one client device is relayed by the communication session server 116 to another client device. Where the communication session server 116 acts as an intermediary, information transmitted by the client devices 104-114 may pass through the communication session server 116, such as audio, video, images, documents, and other types of electronic files. As discussed below, there may be instances where the client device 104 does not have sufficient computing resources to provide the communication session hosting functionalities, in which case, the communication session server 116 is instructed to provide the communication session hosting functions.

The communication session server 116 may also have access to one or more user accounts via a user accounts database 326. A user account in the user account database 326 may include bibliographic information about a user, such as his or her name, phone number, e-mail address, and other such bibliographic information. A user account may also include a security clearance attribute that is assigned a security clearance value. The security clearance attribute indicates the level of confidential material to which the user associated with the user account has access.

In general, a user cannot view or access material having a confidentiality value that exceeds the user's own security clearance value. However, there may be times when an object, appearing in a video during a communication session, has a confidentiality value that exceeds the security clearance of one or more user accounts attending the communication session. As discussed above, the client device 104 is configured to obfuscate the object for those user accounts that do not have the requisite security clearance to view the object. In one embodiment, when the communication session is initially established among the client devices 104-114, the client device 104 may query the communication session server 116 to obtain the security clearance values of the user accounts attending the communication session. The communication session server 116 may query the user accounts database 326 to obtain this information, and transfer it to the client device 104 via one or more of the application(s) 308, such as the communication session hosting application 318. The client device 104 may periodically query the communication session server 116 for updates on the security clearance values of the user accounts attending the communication session, such as when a user account is added to the communication session.

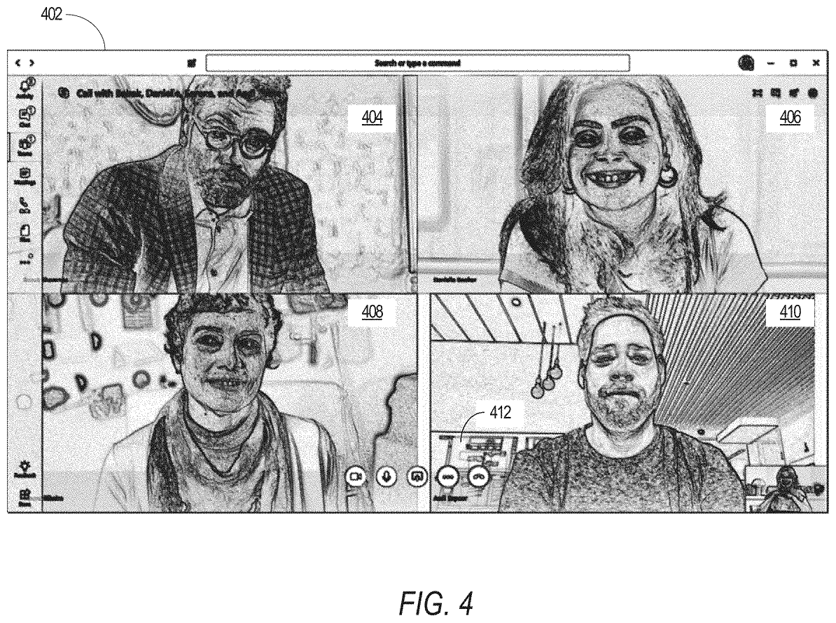

Turning now to FIG. 4 is an example of a video being displayed during a communication session. FIG. 4 illustrates a graphical user interface 402 where client devices are communicating via a video conference, according to an example embodiment. In FIG. 4, the graphical user interface 402 includes four video streams 404-410, where the video streams are live video streams 404-410. Each of the video streams 404-410 may correspond to a user account and/or client device (e.g., one or more of the client devices 104-114). In video stream 410, the obfuscation module 216 has detected an object 412 to be obfuscated. The obfuscation module 216 compares each video frame of the video stream 410 with the obfuscation model 224 to obtain a probability value that the video frame includes an object to be obfuscated along with a plurality of two-dimensional coordinates that define a bounding shape (e.g., a square, a rectangle, a polyhedron, etc.), for the object to be obfuscated.

The obfuscation module 216 compares the obtained probability value with a probability threshold to make a determination as to whether the detected object (e.g., object 412) is to be obfuscated. In the example shown in FIG. 4, the obfuscation module 216 has determined that the object 412 is to be obfuscated (e.g., that the probability value associated with the object 412 is greater than or equal to the probability threshold).

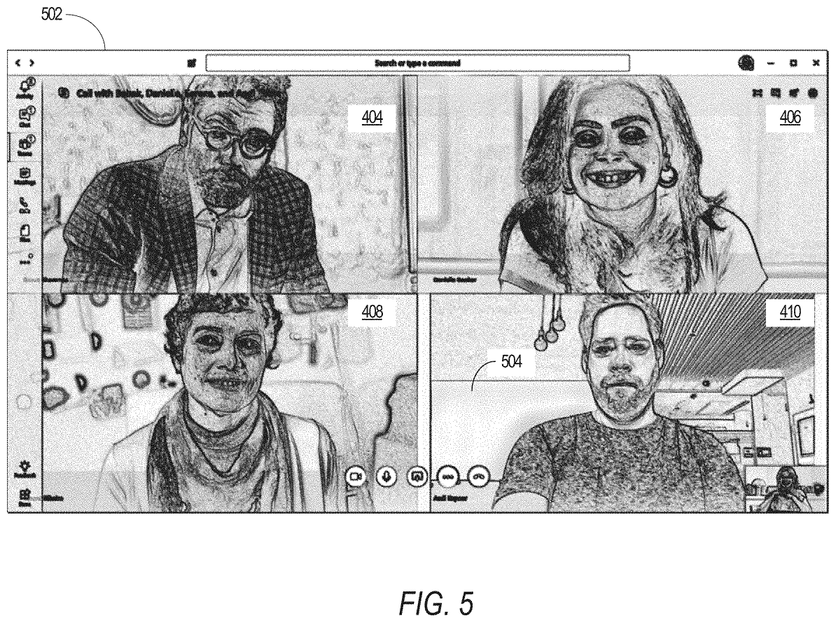

FIG. 5 illustrates a graphical user interface 502 where the object 412 has been obfuscated in one of the video streams 410 of the client devices illustrated in FIG. 4, according to an example embodiment. In FIG. 5, the obfuscation module 216 has performed an obfuscation technique on a portion of the video frame from FIG. 4, and has replaced the video frame of FIG. 4, with the obfuscated video frame shown in FIG. 5. In FIG. 5, the previously non-obfuscated object 412 is obfuscated (referred to as the obfuscated object 504). With the video frame shown in FIG. 5, the obfuscation module 216 has obfuscated an interior portion of the non-obfuscated object 412 such that the contents of the non-obfuscated object 412 are obfuscated. As discussed above, the obfuscation module 216 may be configured to perform this selective obfuscation by first determining which shapes and/or objects are to be obfuscated (e.g., the words, letters, and/or images), performing edge detection to identify edges that enclose the detected shapes and/or objects, and then obfuscating the shapes and/or objects that are enclosed by the identified edges.

Another notable detail is that the obfuscation performed by the obfuscation module 216 occurred while the video stream 410 was being transmitted and without requiring a user (e.g., the user appearing in the video stream 410 or another user) to specifically identify the non-obfuscated object 412. While the client device 104 may be capable of allowing a user to manually identify the non-obfuscated object 412, this task cannot be performed manually in any meaningful way while the video stream (live or prerecorded) is being transmitted. This is because each second of the video stream may result in 24 video frames (e.g., 24 frames per second) and a person is simply not fast enough to review each video frame, determine whether the video frame includes content or an object to be obfuscated, identify the coordinates of the shape where the obfuscation is to occur, and then apply the obfuscation technique to the shape identified by the coordinates. Furthermore, this disclosure extends the concept of obfuscating a portion of a video frame by allowing authorized users view the non-obfuscated object 412 without the obfuscation. Manually performing this determination would also be too slow compared to the implementation described herein.

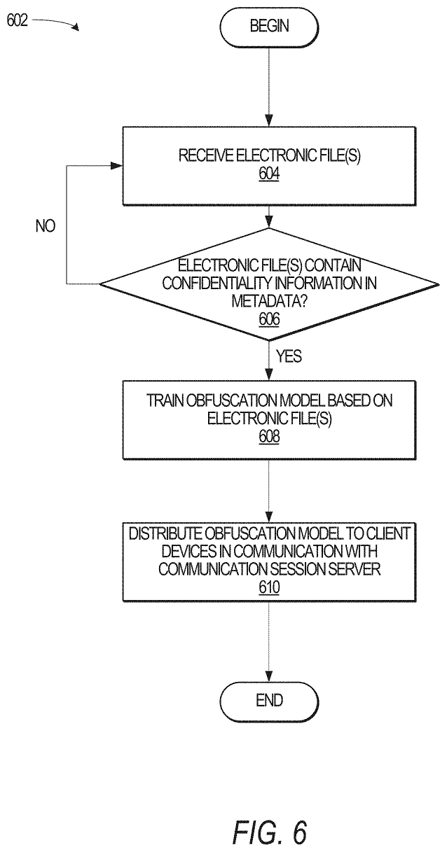

FIG. 6 illustrates a method 602, in accordance with an example embodiment, for training and updating an obfuscation model for the client devices of FIG. 1. The method 602 may be implemented by one or more of the components illustrated in FIGS. 2-3 and is discussed by way of reference thereto.

Initially, the communication session server 116 receives electronic file(s) 320 from one or more of the client devices 104-114 via the DMS 312 and the DMS access client 214 (Operation 604). In one embodiment, the electronic file(s) 320 are stored in the DMS database 118. The DMS database 118 may include those electronic file(s) that the users of the client devices 104-114 consider confidential or restricted. In an alternative embodiment, the DMS database 118 includes a mixture of confidential and/or restricted electronic file(s) and non-confidential electronic file(s), and the electronic file(s), both confidential and non-confidential, include confidentiality attributes in metadata that identify whether a corresponding electronic file is confidential and/or restricted. In some instances where metadata is used, and as discussed above, the confidentiality attribute values may be a gradient, with some electronic files being designated as more confidential than others.

In FIG. 6, the machine-learning application 314 trains an obfuscation model 322 using one or more of the electronic files 320 stored in the DMS database 118 based on the confidentiality attribute value contained within the metadata of the electronic file(s) 320 (Operation 606). As explained above, examples of the machine-learning algorithms implemented by the machine-learning application 114 include, but are not limited to, CART, R-CNN, YOLO, and other such algorithms. Where the metadata for an electronic file does not identify the electronic file as confidential and/or restricted, the electronic file (e.g., the contents of the electronic file) may not be included in the training dataset used to train the obfuscation model 322 (e.g., the “NO” branch of Operation 606). Conversely, where the metadata for an electronic file identifies the electronic file as confidential and/or restricted, the electronic file (e.g., the contents of the electronic file) may be included in the training dataset used to train the obfuscation model 322 (e.g., the “YES” branch of Operation 606).

After the machine-learning application 314 determines the initial training dataset of electronic files 320, the machine-learning application 314 trains the obfuscation model 322 (Operation 608). After the obfuscation model 322 is trained with the initial training dataset of electronic files, the communication session server 116 then transfers or communicates the obfuscation model 322 to one or more of the client devices 104-114 (Operation 610). The communication session server 116 communicates the obfuscation model 322 to each of the clients 104-114 to ensure that each of the clients 104-114 have a local copy of the obfuscation model 322 (e.g., stored as the obfuscation model 224).

Although FIG. 6 illustrates one instance of training an obfuscation model, one of ordinary skill in the art will appreciate that one or more of Operations 606-610 may be repeated to update and/or modify an existing obfuscation model 322. For example, additional electronic files may be added to the DMS database 118 after the communication session server 116 has trained an obfuscation model 322. Accordingly, the communication session server 116 may re-train an obfuscation model 322 periodically, such as nightly, hourly, and so forth, to ensure that the obfuscation model 322 includes the most current, and confidential, electronic files of the DMS database 118. In another embodiment, the communication session server 116 may re-train the obfuscation model 322 in response to an electronic file be added to, or removed from, the DMS database 118. This approach ensures that the obfuscation model 322 is trained with the most current, and confidential, electronic files of the DMS database 118.

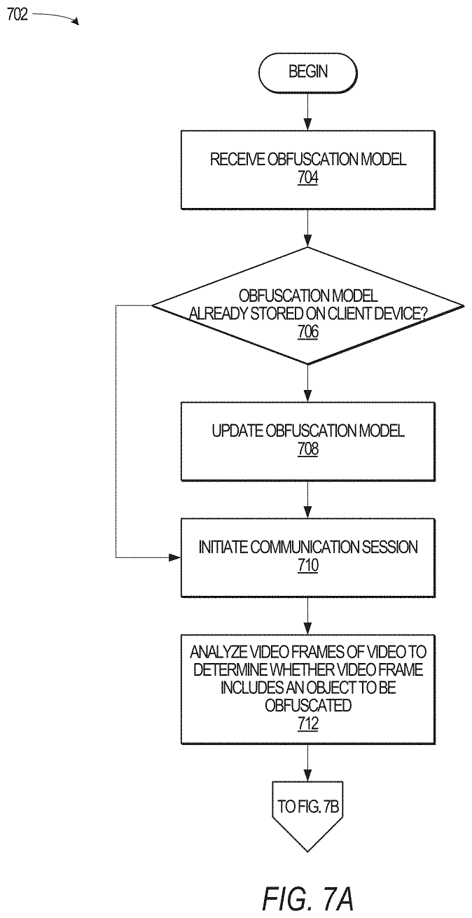

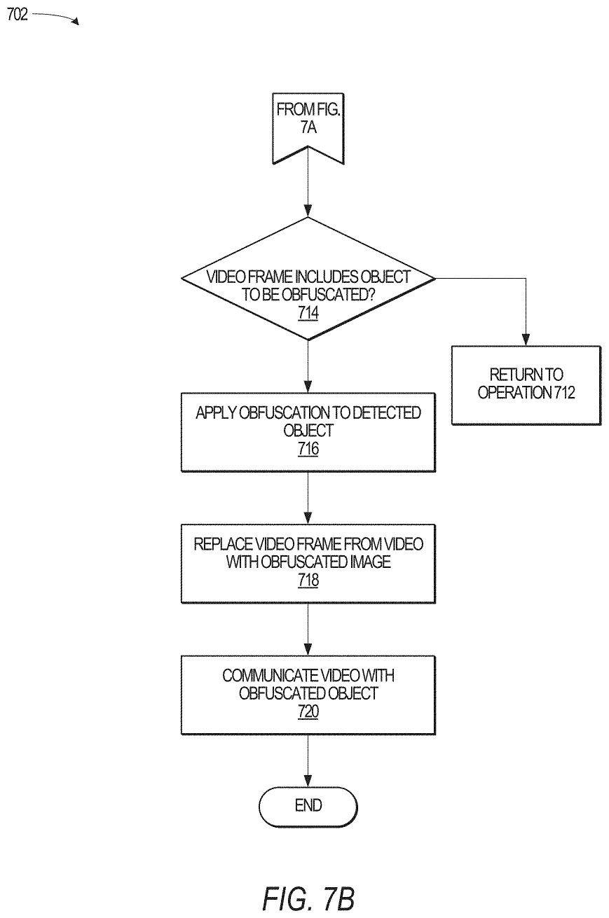

FIGS. 7A-7B illustrate a method 702, in accordance with an example embodiment, for obfuscating an object appearing in a video stream communicated by one of the client devices 104-114 illustrated in FIG. 1. The method 702 may be implemented by one or more of the components and/or devices illustrated in FIGS. 2-3, and is discussed by way of reference thereto.

Referring initially to FIG. 7A, a client device, such as client device 104, receives an obfuscation model from the communication session server 116 (Operation 704). The client device 104 then executes the obfuscation module 216 to determine whether the client device 104 has already stored an obfuscation model (e.g., obfuscation model 224) (Operation 706). Where the client device does not have an existing obfuscation model 224 (e.g., the “NO” branch of Operation 706), the method 702 proceeds to Operation 710). Alternatively, where the client device 104 does have an existing obfuscation model 224 (e.g., the “YES” branch of Operation 706), the obfuscation module 216 then updates the obfuscation model 224 currently existing on the client device 104 with the obfuscation model transmitted by the communication session server 116 (Operation 708). Updating the obfuscation model 224 may include replacing the entirety of the obfuscation model 224 or portions thereof.

At Operation 710, the user of the client device 104 may initiate a communication session with one or more of the client devices 106-114, which may be similar to the communication session illustrated in FIGS. 4-5 above. In one embodiment, the communication session includes streaming a video (e.g., content 218) captured by the camera 228 communicatively coupled to the client device 104. Alternatively, the communication session may involve the transmission of a pre-recorded video stored on the client device 104.

The obfuscation module 216 then analyzes the video frames of the content 218 to determine whether the video frames contain or show an object to be obfuscated (Operation 712). As discussed above, the obfuscation module 216 may implement the object detection on the video frames using the obfuscation model 224 and/or the one or more image template(s) 226. In one embodiment, the output from the comparison of the video frame with the obfuscation model 224 is a probability value that the video frame includes an object to be obfuscated. In another embodiment, the output includes a plurality of probability values associated with corresponding confidentiality values. As discussed above, assigning a corresponding confidentiality value to the detected object may be leveraged by the obfuscation module 216 to selectively obfuscate the detected object for one or more user accounts attending the communication session.

Referring to FIG. 7B, the obfuscation module 216 then determines whether a video frame includes an object to be obfuscated (Operation 714). In one embodiment, the obfuscation module 216 determines whether the video includes an object to be obfuscated by comparing the determined probability value that the video frame includes an object to be obfuscated with a probability threshold value. The obfuscation module 216 may determine that the video frame includes an object to be obfuscated where the probability value meets or exceeds the probability threshold value. Where the obfuscation module 216 determines that the video frame does not include an object to be obfuscated (e.g., the “NO” branch of Operation 714), the method 702 returns to Operation 712, where the obfuscation module 216 processes a next video frame in the content 218. Alternatively, where the obfuscation module 216 determines that the video includes an object to be obfuscated (e.g., the “YES” branch of Operation 714), the method 702 proceeds to Operation 716.

At Operation 716, the obfuscation module 216 applies an obfuscation technique to a portion of the video frame where the obfuscation module 216 determined that the detected object is located. As previously explained, the location of the detected object may be identified by a plurality of two-dimensional coordinates output by the obfuscation model 224 and/or through edge detection after determining the location of an obfuscation marker using one or more of the image template(s) 226. As also discussed above, the obfuscation module 216 may apply various image processing and/or image manipulation techniques to obfuscate the detected object, such as edge detection (to detect the edges of the object), a Gaussian blur (to blur the detected object or contents displayed by the detected object), blocking (to block the detected object or contents displayed by the detected object), pixelation (to pixelate the detected object or contents displayed by the detected object), or any other such image processing and/or image manipulation technique that results in the obfuscation of the detected object. The result of processing the video frame in this manner is an obfuscated image 220, which may be stored in a data buffer of the client device 104. The client device 104 may buffer the content 218 and/or one or more of the obfuscated image(s) 220 to ensure that the obfuscation module 216 has sufficient time to process the video frame before the content 218 is communicated to one or more of the client devices 106-114. In addition, buffering the content 218 allows the client device 104 to deliver a video without significant interruptions, as the obfuscation processes are occurring while the video is buffered.

In the method 702 of FIG. 7B, the obfuscation module 216 replaces the video frame with the non-obfuscated object with its corresponding obfuscated image 220, where the object appears obfuscated. Alternatively, the obfuscation module 216 may modify the data bits of the video frame itself and alter portions of the video frame without replacing the video frame (e.g., those portions where the obfuscation module 216 determined the detected object was located). The communication client 212 then communicates the content 218 with the detected object appearing obfuscated to one or more of the user accounts attending the communication session (Operation 720).

Although FIG. 7B is discussed with reference to operations of the client device 104, the communication session server 116 may be configured to perform one or more of the obfuscation operations and/or hosting operations (e.g., delivering the video to one or more of the client devices 104-114) depending on the computing resources available to the client device 104. In one embodiment, the communication session hosting application 318 provides communication session hosting functionalities (e.g., receipt of communication session data, re-transmission of communication session data, etc.) and/or one or more of the obfuscation methodologies described with reference to the obfuscation module 216 (e.g., the communication session hosting application 318 may be extended to include its own obfuscation module (not shown)).

When a communication session is initially requested by the client device 104, the communication client 212 may query the communication session hosting application 318 to determine whether the communication session server 116 is configured to operate as a communication session host and, if so, whether the communication session server 116 has computing resources available to host the communication session. This operation may be performed where the communication client 212 determines that the client device 104 does not have a minimum amount of computing resources available to it (e.g., by querying the operating system of the client device 104). Accordingly, where the communication client 212 determines that the client device 104 does not have sufficient computing resources to conduct the communication session and/or perform the obfuscation operations on the content 218, the communication client 212 may request that the communication session hosting application 318 perform the functions that would be performed by the client device 104. In this manner, the communication session server 116 may operate as an intermediary between the client device 104 and the other client devices 106-114, such that the client device 104 sends the content 218 to the communication session server 116 for obfuscation, the communication session server 116 performs the obfuscation operations on the received content 218, and then re-transmits the content 218 with any obfuscated objects. Thus, the obfuscation operations disclosed herein may be performed by the communication session server 116 according to the operations described with reference to the client device 104 and FIG. 2.

### Modules, Components, and Logic

Certain embodiments are described herein as including logic or a number of components, modules, or mechanisms. Modules may constitute either software modules (e.g., code embodied on a machine-readable medium or machine-readable storage device) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a FPGA or an ASIC. A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-7B are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things” while yet another combination produces a server computer for use within a cloud computing architecture. Not all combinations of such software and hardware architectures are presented here as those of skill in the art can readily understand how to implement the inventive subject matter in different contexts from the disclosure contained herein.

### Example Machine Architecture and Machine-Readable Medium

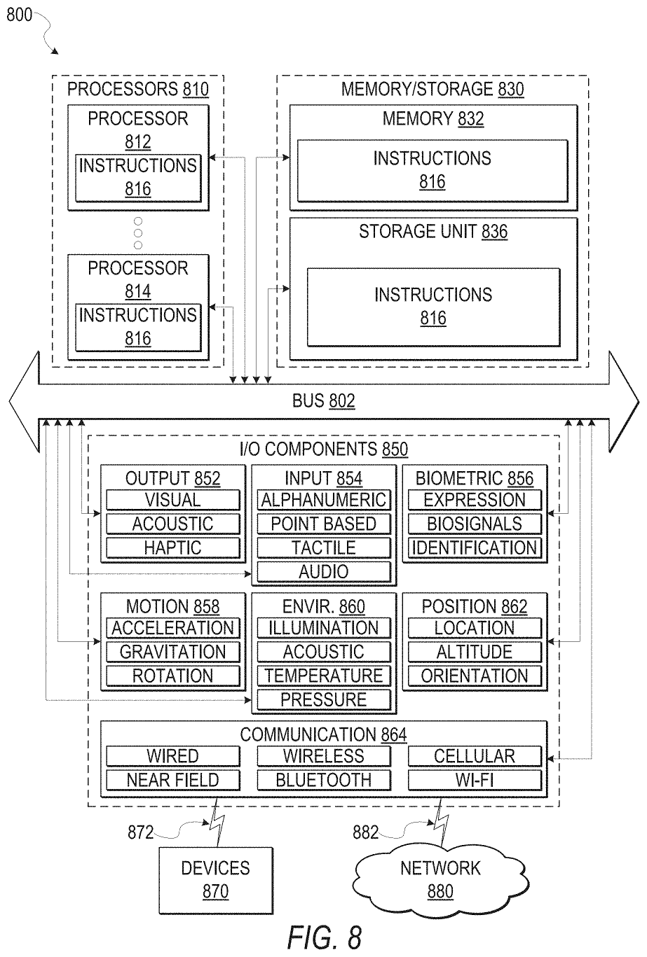

FIG. 8 is a block diagram illustrating components of a machine 800, according to some example embodiments, able to read instructions from a machine-readable medium (e.g., a machine-readable storage medium or machine-readable storage device) and perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute the methods illustrated in FIGS. 6-7B. Additionally, or alternatively, the instructions 816 may implement one or more of the components of FIGS. 1-3. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a PDA, or any machine capable of executing the instructions 816, sequentially or otherwise, that specify actions to be taken by machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory/storage 830, and I/O components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, processor 812 and processor 814 that may execute the instructions 816. The term “processor” is intended to include multi-core processor that may comprise two or more independent processors (sometimes referred to as “cores”) that may execute instructions 816 contemporaneously. Although FIG. 9 shows multiple processors 810, the machine 800 may include a single processor with a single core, a single processor with multiple cores (e.g., a multi-core process), multiple processors with a single core, multiple processors with multiples cores, or any combination thereof.

The memory/storage 830 may include a memory 832, such as a main memory, or other memory storage, and a storage unit 836, both accessible to the processors 810 such as via the bus 802. The storage unit 836 and memory 832 store the instructions 816 embodying any one or more of the methodologies or functions described herein. The instructions 816 may also reside, completely or partially, within the memory 832, within the storage unit 836, within at least one of the processors 810 (e.g., within the processor's cache memory), or any suitable combination thereof, during execution thereof by the machine 800. Accordingly, the memory 832, the storage unit 836, and the memory of processors 810 are examples of machine-readable media.

As used herein, “machine-readable medium” includes a machine-readable storage device able to store instructions 816 and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862 among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via coupling 882 and coupling 872, respectively. For example, the communication components 864 may include a network interface component or other suitable device to interface with the network 880. In further examples, communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF416, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 880 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or other type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to devices 870. The term “transmission medium” shall be taken to include any intangible medium that is capable of storing, encoding, or carrying instructions 816 for execution by the machine 800, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A method for determining whether to obscure a portion of an image, the method comprising:
receiving first content data for video streaming to a remote device;
determining that a portion of the first content data includes a feature by parsing the first content data, wherein:
the feature is defined by a predetermined metadata confidentiality attribute value embedded in, and received with, the first content data and separate from image data of the first content data, wherein the predetermined metadata confidentiality attribute value is indicative of a confidentiality level of the portion of the first content data; or
the feature comprises second content matching a portion of data in an identified electronic file of a plurality of electronic files stored in a database, wherein the identified electronic file is marked in the database for obfuscation, and wherein another file of the plurality of electronic files is not marked in the database for obfuscation;
obfuscating the portion of the first content data in an output video stream in response to the determination that the portion of the first content data includes the feature; and
subsequent to obfuscating the portion of the first content data, communicating the output video stream to the remote device, wherein the output video stream comprises the obfuscated portion of the first content data.

2. The method of claim 1, wherein the feature is defined by the predetermined metadata confidentiality attribute value embedded in the first content data.

3. The method of claim 1, wherein:
the first content data comprises a plurality of image frames; and
the predetermined metadata confidentiality attribute value specifies a physical object having been identified in an image frame of the plurality of image frames.

4. The method of claim 1, wherein:
the feature is defined by the second content data from the at least one file stored in the database;
the first content data comprises a plurality of image frames; and
determining that the portion of the first content data includes the feature comprises comparing at least a portion of the image frame selected from the plurality of image frames with the second content data.

5. The method of claim 1, wherein:
receiving the first content data comprises receiving a live video stream from an image sensor in communication with a client device; and
communicating the output video stream comprises transmitting the live video stream after obfuscating the portion of the first content data.

6. The method of claim 1, wherein determining that the portion of the first content data includes the feature comprises:
storing the first content data in a data buffer; and
performing the determination on the first content data stored in the data buffer.

7. The method of claim 1, wherein obfuscating the portion of the first content data comprises blurring the portion of the first content data.

8. The method of claim 1, further comprising:
determining whether a user account having access to the output video stream is authorized to view the portion of the first content data determined as including the feature; and wherein
obfuscating the portion of the first content data is further based on a determination that the user account is not authorized to view the portion of the first content data.

9. The method of claim 1, further comprising:
receiving a request from a client device, invoking a stream function, to stream the first content data to a plurality of remote devices logged into a communication session;
in response to the received request, negotiating with the client device to receive the first content data; and
streaming the output video stream to at least one of the plurality of remote devices.

10. A system for determining whether to obscure a portion of an image, the system comprising:
a computer storage device having computer-executable instructions stored thereon; and
a processor that, having executed the computer-executable instructions, configures a system to perform a plurality of operations comprising:
receiving first content data for video streaming to a remote device;
determining that a portion of the first content data includes a feature by parsing the first content data, wherein:
the feature is defined by a predetermined metadata confidentiality attribute value embedded in, and received with, the first content data and separate from image data of the first content data, wherein the predetermined metadata confidentiality attribute value is indicative of a confidentiality level of the portion of the first content data; or
the feature comprises second content matching a portion of data in an identified electronic file of a plurality of electronic files stored in a database, wherein the identified electronic file is marked in the database for obfuscation, and wherein another file of the plurality of electronic files is not marked in the database for obfuscation;
obfuscating the portion of the first content data in an output video stream in response to the determination that the portion of the first content data includes the feature; and
subsequent to obfuscating the portion of the first content data, communicating the output video stream to the remote device, wherein the output video stream comprises the obfuscated portion of the first content data.

11. The system of claim 10, wherein the feature is defined by the predetermined metadata confidentiality attribute value embedded in the first content data.

12. The system of claim 10, wherein:
the first content data comprises a plurality of image frames; and
the predetermined metadata confidentiality attribute value specifies a physical object having been identified in an image frame of the plurality of image frames.

13. The system of claim 10, wherein:
the feature is defined by the second content data from the at least one file stored in the database;
the first content data comprises a plurality of image frames; and
determining that the portion of the first content data includes the feature comprises comparing at least a portion of the image frame selected from the plurality of image frames with the second content data.

14. The system of claim 10, wherein:
receiving the first content data comprises receiving a live video stream from an image sensor in communication with a client device; and
communicating the output video stream comprises transmitting the live video stream after obfuscating the portion of the first content data.

15. The system of claim 10, wherein determining that the portion of the first content data includes the feature comprises:
storing the first content data in a data buffer; and
performing the determination on the first content data stored in the data buffer.

16. The system of claim 10, wherein obfuscating the portion of the first content data comprises blurring the portion of the first content data.

17. The system of claim 10, wherein the plurality of operations further comprise:
determining whether a user account having access to the output video stream is authorized to view the portion of the first content data determined as including the feature; and wherein
obfuscating the portion of the first content data is further based on a determination that the user account is not authorized to view the portion of the first content data.

18. The system of claim 10, wherein the plurality of operations further comprise:
receiving a request from a client device, invoking a stream function, to stream the first content data to a plurality of remote devices logged into a communication session;
in response to the received request, negotiating with the client device to receive the first content data; and
streaming the output video stream to at least one of the plurality of remote devices.

19. A system for determining whether to obscure a portion of an image, the system comprising:
means for receiving first content data for video streaming to a remote device;
means for determining that a portion of the first content data includes a feature by parsing the first content data, wherein:
the feature is defined by a predetermined metadata confidentiality attribute value embedded in the first content data and separate from image data of the first content data, wherein the predetermined metadata confidentiality attribute value is indicative of a confidentiality level of a portion of the first content data; or
the feature comprises second content data from at least one file stored in a database, wherein the at least one file is marked in the database for obfuscation;
means for obfuscating the portion of the first content data in an output video stream in response to the determination that the portion of the first content data includes the feature; and
means for communicating the output video stream to the remote device subsequent to obfuscating the portion of the first content data, wherein the output video stream comprises the obfuscated portion of the first content data.

20. The system of claim 19, wherein the feature is defined by the predetermined metadata confidentiality attribute value embedded in the first content data.

21. The system of claim 19, wherein:
the first content data comprises a plurality of image frames; and
the predetermined metadata confidentiality attribute value specifies a physical object having been identified in an image frame of the plurality of image frames.

22. The system of claim 19, wherein:
the feature is defined by the second content data from the at least one file stored in the database;
the first content data comprises a plurality of image frames; and
the means for determining that the portion of the first content data includes the feature comprises comparing at least a portion of the image frame selected from the plurality of image frames with the second content data.

23. The system of claim 19, wherein:
the means for receiving the first content data further receives a live video stream from an image sensor in communication with a client device; and
the means for communicating the output video stream further transmits the live video stream after obfuscating the portion of the first content data.

24. The system of claim 19, wherein the means for determining that the portion of the first content data includes the feature further:
stores the first content data in a data buffer; and
performs the determination on the first content data stored in the data buffer.

25. The system of claim 19, wherein the means for obfuscating the portion of the first content data further blurs the portion of the first content data.

26. The system of claim 19, further comprising:
means for determining whether a user account having access to the output video stream is authorized to view the portion of the first content data determined as including the feature; and wherein
the means for obfuscating the portion of the first content data further obfuscates the portion of the first content data based on a determination that the user account is not authorized to view the portion of the first content data.

27. The system of claim 19, further comprising:
means for receiving a request from a client device, invoking a stream function, to stream the first content data to a plurality of remote devices logged into a communication session;
means for negotiating with the client device to receive the first content data in response to the received request; and
means for streaming the output video stream to at least one of the plurality of remote devices.
